(19) United States
(12) Patent Application Publication
(10) Pub. No.: US 2005/0274055 A1
(43) Pub. Date: Dec. 15, 2005

(54) Color-changing fishing equipment

(76) Inventors: Roger B. Cook, Spirit Lake, IA (US); Arsalan D. Azari, Spirit Lake, IA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/863,525

(22) Filed: Jun. 9, 2004

(51) Int. Cl. A01K 91/00

(52) U.S. Cl. 43/44.98

(57) ABSTRACT

Fishing equipment incorporates one or more dyes that change or display colors upon exposure to light (photochromic), a change in temperature (thermochromic), or change in ambient moisture (solvatochromic). Products that include parts that are made of, or products which are wholly a polymer can benefit from the present invention and may include fishing lines, fishing rods, fishing reels, thread used to wrap line guides on a fishing rod, and fishing reel handles.

### FIELD OF INVENTION

The invention relates to polymeric components used in fishing that include one or photochromic (light sensitive), thermochromic (heat sensitive), or solvachromic (sensitive to solvents) dyes incorporated therein.

### BACKGROUND OF THE INVENTION

Dyes and coloring agents represent one of the more ubiquitous aspects of fishing equipment that serve several functions. Most notably, anglers are presented with a number of different possible colors for fishing lines. The color selected is often a matter of personal preference in the balance of benefits and detriments in the desired degree of line visibility above and below the water which can affect the selected lure, manipulation of that lure, and the type of fish that would be attracted.

Color is also used by manufacturers to present a pleasing product appearance that can distinguish its products from those of competitors on an extended display rack. Notably, fishing rod blanks are frequently colored red, black, or white under a clear gloss or matte finish coating with line guide wrapping thread that is red, black, white, or gold. Fishing rod handles are often made of a black polymer with one or more sections of natural or synthetic cork or a grippable elastomer. External components of fishing reels at various price points may also be made of one or more molded polymers that present a desired appearance as well as performing certain functions within the reel.

It would be desirable to have a means for providing a unique color or appearance to fishing equipment that would provide visual-based indicia that would enhance performance of the fishing equipment.

### SUMMARY OF THE INVENTION

It is an objective of the invention to provide polymer coloring agents that can enhance the performance and usefulness of fishing equipment in or on which they are used.

It is a further objective of the invention to provide a system for providing fishing equipment with interesting and attractive color-based properties.

In accordance with these and other objectives of the invention that will become apparent from the description herein, fishing equipment according to the invention comprises: (a) a product having at least one polymeric component, wherein said product is useful in the sport of fishing; and (b) at least one color-changing agent comprising a dye, pigment, or formulation disposed within, on, or distributed throughout said polymeric component, wherein said color-changing agent changes its perceived color as a consequence of a change in ambient electromagnetic radiation (photochromic), temperature (thermochromic), or moisture level (solvatochromic).

Fishing products according to the invention use a reversible color-changing agent to enhance performance of the color-changing product. Fishing lines can appear one color above water and another, more camouflaged color under water. This would provide the angler with the benefits associated with an ability to see and track the line while also hiding the fishing line from fish.

### DETAILED DESCRIPTION OF THE INVENTION

Polymeric fishing lines, lures, and polymeric equipment or components thereof useful for fishing are made with a polymer having dispersed therein or thereon one or more photochromic, thermochromic, or solvatochromic dyes. When exposed to sunlight or wavelengths of radiation to which they are sensitive, the photochromic dyes will produce a color change over those areas exposed to the sunlight or radiation. Thermochromic dyes respond to changes in temperature as when a fishing line in relatively warm air descends into relatively cooler water. Solvatochromic dyes respond to the presence of solvents (such as water) to present one color when dry and another when wet. Such controls on color change can enhance performance and fishing ease of the equipment.

For example, fishing lines that incorporate one or more light sensitive (photochromic), temperature sensitive (thermochromic), or moisture sensitive (solvatochromic) dyes can be engineered to present a relatively visible appearance above water but a darker, more obscure color profile below water. Additionally, fishing lines that incorporate one or more photochromic dyes whose period of color change sensitivity is chosen or modified to correspond with the rated exposure period of the fishing line to sunlight and ultraviolet radiation. The angler is provided with a visual indication (via the lack of color change upon exposure to sunlight) that the line on that reel should be changed.

Fishing lures that contain one or more photochromic, thermochromic, or solvachromic dyes would experience color changes in moving between depths and bright or shaded areas that would heighten the visual attraction of the lure to predatory fish. With appropriate selection of the dye or dyes, the color changes could correspond to the visual appearance of natural prey for improved effectiveness against predators that are sensitive, at least in part, to visual stimulation.

Fishing rods and fishing reels all have polymeric components that could incorporate one or more photochromic, thermochromic, or solvachromic dyes for a unique visual appearance. For example, fishing rod blanks, line guide thread, or reel handles could be made photochromic for a distinctive visual appearance in a suitably illuminated store display as well as outside when fishing during the daylight hours.

As used herein and unless otherwise specified, all percentages are by weight of total composition.

Polymers should be chosen for combination with the dye or dyes according to the invention that are suitable for the fishing equipment product in question. For example, fishing lines require good tenacity, low stiffness, low to no stretch when submerged in water, good abrasion resistance, as well as resistance to solvents, ultraviolet light, and ozone. Suitable polymers for use in fishing lines include polyamides alone or in combination, polyesters, polyolefins, gel spun polyolefins (see, U.S. Pat. Nos. 5,540,990 and 6,148,597), fluoropolymer, and the like. Preferred polymers for use in fishing lines include one or more polyamides, gel spun polyolefins, and fluoropolymers for monofilament lines and polyesters for braided fishing lines.

The thread wrapping used to secure a line guide foot to the surface of a fishing rod can also be dyed according to the present invention. Such threads are typically multifilament yarns made of polyester that can be surface coated with dye according to the invention by passing the thread thru a coating bath that contains the desired dye or by adding the dye to the spinning solution for a continuous color throughout the yarn.

In contrast, fishing reel components should be relatively rigid, durable, highly resistant to oils, silicones, and various petroleum-based solvents. Suitable polymers for use in molded fishing reel components include nylon, glass-filled nylon, and similar materials. One or more dyes can be incorporated into the molten resin for external functional parts that could also have ornamental appeal.

Fishing rod are conventionally made from prepreg composites that contain oriented carbon fibers in a resinous matrix, often based on epoxy resins. The prepreg is rolled onto a tapered mandrel, wrapped in heat shrink cellophane, and cured in a curing oven. The mandrel is removed, and the cured blank is sanded, coated with a finishing resin, and cured again. One or more dyes could be incorporated into the epoxy resin of the prepreg, applied to the surface (inside or outside) of the blank, or to the finish coating applied to the sanded blank. See, U.S. Pat. No. 5,964,056.

Fishing rod handles often have molded components or are made from a unitary molded part. Suitable polymers that can be used to make fishing rod handles include nylon, glass-filled nylon, and the like. One or more dyes can be incorporated into the resin before molding or applied as an outside coating to the molded handle.

Polymeric fishing lures are generally either hard bodied, soft-bodied, or semi-flexible. Hard-bodied lures are made by molding polyurethanes, polyethylene, and nylon. Soft-bodied lures are made by casting a plastisol into a mold having the desired lure shape and allowing the molten plastisol to cool until cured. See, U.S. Pat. Nos. 5,827,551 and 6,269,586.

Suitable photochromic dyes for use in the present invention include organic photochromic compounds that are compatible with and stable in polymeric resins which also are resistant to the high heats used in connection with forming polymeric mono- and multifilament fishing lines as well as casting and/or curing operations associated with the forming of fishing rods, fishing lures, or components used in fishing reels. Organic photochromic compounds contemplated for use in the present invention have at least one activated absorption maxima within the range of between about 400 and 700 nanometers, or substances containing the same. The photochromic compounds can each be used alone or in combination with one or more other organic photochromic materials, stabilizing agents, flow aids, etc.

Exemplary photochromic materials include azobenzene compounds, thioindigo compounds, dithizone metal complexes, spiropyran compounds, spirooxazine compounds, fulgide compounds, dihydropyrene compounds, spirothiopyran compounds, 1,4-2H-oxazine, triphenylmethane compounds, viologen compounds, pyran compounds, oxazine compounds, chromenes, e.g., naphthopyrans, benzopyrans, indenonaphthopyrans and phenanthropyrans; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides, polymerizable photochromic compounds (such as those disclosed in U.S. Pat. Nos. 4,719,296; 5,166,345; 5,236,958; 5,252,742; 5,359,035; 5,488,119 and 6,113,814), and mixtures of such photochromic compounds. Such photochromic compounds and complementary photochromic compounds are described in U.S. Pat. Nos. 5,645,767, 5,658,501, 6,153,126, 6,296,785, 6,348,604 and 6,353,102 whose disclosures are herein incorporated by reference.

Other photochromic substances contemplated are organo-metal dithiozonates, i.e., (arylazo)-thioformic arylhydrazidates, e.g., mercury dithizonates which are described in, for example, U.S. Pat. No. 3,361,706; and fulgides and fulgimides, e.g., the 3-furyl and 3-thienyl fulgides and fulgimides, which are described in U.S. Pat. No. 4,931,220 at column 20, line 5 through column 21, line 38. It is also possible to apply a layer containing an organic photochromic substance resistant to the effects of a polymerization initiator can also be added to the coating composition. Such organic photochromic substances include photochromic compounds encapsulated in metal oxides, the latter of which are described in U.S. Pat. Nos. 4,166,043 and 4,367,170 whose disclosures are herein incorporated by reference.

Of the above compounds, spiropyran compounds, spirooxazine compounds, pyran compounds, and oxazine compounds are excellent in the sensitivity to coloring and in the color density.

Examples of suitable spirooxazine-type compounds are disclosed is U.S. Pat. No. 5,208,132 (which is herein incorporated by references) and include: 1,3,3-trimethylspiro[indoline-2,3′-(3H)naphtho(2,1-b)(1,4)-oxazine]; 5-chloro-1,3,3-trimethylspiro[indoline-2,3′-(3H)naphtho(2,1-b)(1,4)-oxazine]; 1,3,3,5-tetramethylspiro[indoline-2,3′-(3H)naphtho(2,1-b)(1,4)-oxazine]; 1,3,3-trimethyl-9′-methoxyspiro[indoline-2,3′-(3H)naphtho(2,1-b)(1,4)-oxazine]; 1,3,3,5-tetramethyl-9′-methoxyspiro[indoline-2,3′-(3H) naphtho(2,1-b)(1,4)-oxazine]; 1,3,3,5,6-pentamethyl-9′-methoxyspiro[indoline-2,3′-(3H) naphtho(2,1-b)(1,4)-oxazine]; 4-trifluoromethyl-1,3,3-trimethyl-5′-methoxyspiro[indoline-2,3′-(3H) naphtho (2,1-b) (1,4)-oxazine]; 6′-trifluoromethyl-1,3,3,-trimethyl-5′-methoxyspiro[indoline-2,3′-(3H)naphtha (2,1-b)(1,4)-oxazine]; 4-trifluoromethyl-1,3,3-trimethyl-9′-methoxyspiro[indoline-2,3′-(3H)naphtha (2,1-b) (1,4)-oxazine]; 1,3,5,6-tetramethyl-3-ethylspiro[indoline-2,3′-(3H) pyrido (3,2-f)(1,4)-benzooxazine]; 1,3,3,5,6-pentamethylspiro[indoline-2,3′-(3H) pyrido (3,2-f)(1,4)-benzooxazine]; 1-methyl-3,3-diphenylspiro[indoline-2,3′-(3H) pyrido (3,2-f)(1,4-benzooxazine]; 1-benzyl-3,3-dimethylspiro [indoline-2,3′-(3H) naphtha (2,1-b)(1,4)-oxazine]; 1-(4-methoxybenzyl)-3,3-dimethylspiro[indoline-2,3′-(3H) naphtha (2,1-b)(1,4)-oxazine]; 1-(3,5-dimethylbenzyl)-3,3-dimethylspiro[indoline-2,3′-(3H)naphtha (2,1-b)(1,4)-oxazine]; 1-(4-chlorobenzyl)-3,3-dimethylspiro [indoline-2,3′-(3H)naphtha (2,1-b)(1,4)-oxazine]; 1-(2-fluorobenzyl)-3,3-dimethylspiro[indoline-2,3′-(3H) naphtha (2,1-b)(1,4)-oxazine]; 6′-piperidine-1,3,3-trimethylspiro[indoline-2,3′-(3H) naphtha (2,1-b)(1,4)-oxazine]; 6′-indoline-1,3,3-trimethylspiro[indoline-2,3′-(3H) naphtha (2,1-b)(1,4)-oxazine]; and a compound represented by the formula:

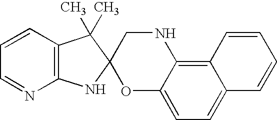

Examples of preferred spiropyran-type compounds are disclosed in U.S. Pat. No. 5,208,132 and include: 1-(2,3,4,5-pentamethylbenzyl)-3,3-dimethylspiro[indoline-2,3′-(3H)naphtho(2,1-b)-pyran] and 1-(2-methoxy-5-nitrobenzyl)-3,3-dimethylspiro[indoline-2,3′-(3H)naphtho(2,1-b)-pyran].

Also suitable photochromic dyes are those materials disclosed in Chapter 1 entitled “Phenomena Involving a Reversible Colour Change” of Bamfeld, Chromic Phenomena: Technological Applications of Colour Chemistry, pp. 7-33, Springer Verlag (2002), the disclosure of which is herein incorporated by reference.

Examples of pyran-type compounds are disclosed in U.S. Pat. No. 5,208,132 and include: 2,2-di-p-methoxyphenylnaphtho (2,1-b) pyran; 2,2-di-p-methoxyphenylphenanthra (2,1-b) pyran; 2,2-diphenylnaphtho (2,1-b) pyran; and 2,2-diphenylphenanthra (2,1-b) pyran.

Thermochromic dyes are inorganic or organic substances which reversibly change their color according to the temperature. According to the invention, thermochromic dyes are preferred which are colorless or dark at a temperature of approximately 15° C. and which change color upon heating or preferably cooling. Particularly preferred are thermochromic dyes which change color at a temperature of about 25° C. or less, preferably within the range of 5 to 20° C., in particular 12 to 20° C.

Thermochromic dyes are preferred which contain an electron donor and an electron acceptor, or dyes which contain an acid-responsive component and an acidic component. Mixtures of an electron-emitting chromogen (electron donor) and an electron acceptor are particularly suitable as thermochromatic dyes on the basis of an electron donor and electron acceptor. Preferred as electron donors are substituted phenyl-methanes, fluoranes, such as for example 3,3′-dimethoxy-fluorane, 3-chloro-6-phenylamino-flourane, 3-diethylamino-6-methyl-7-chlorofluorane, 3-diethyl-7,8-benzofluorane, 3,3′, 3″-tris(p-di-methylaminophenyl)phthalide, 3,3′-bis (p-dimethyl-aminophenyl)-7-phenylaminofluorane and 3-diethyl-amino-6-methyl-7-phenylamino-fluorane, indolylphthalides, spiropy-ranes and cumarins, as well as mixtures of these substances.

Particularly suitable as electron acceptors are phenols, azoles, organic acids and esters as well as salts of organic acids. Examples that may be cited as phenols are phenylphenol, bisphenol A, cresol, resorcinol, chlorolucinol, phenol, phenol oligomers, β-naphthol, 1,5-dihydroxynaphthalene, pyrocatechol, pyrogallol, and the trimer of β-chlorophenol formaldehyde condensate. Examples that may be cited as azoles are benzo-triazoles, such as 5-chlorobenzo-triazole, 4-laurylaminosulfo-benzotriazole, 5-butylbenzotriazole, dibenzotrizaole, 2-oxy-benzotriazole, 5-ethoxy-carbonylbenzo-triazole, 5,5′-methylene-bisbenzotriazole, imidazole, such as oxybenzimidazole, and tetrazole. The organic acids comprise for example aromatic and aliphatic carboxylic acids and substituted derivatives thereof. Examples of aromatic carboxylic acids are salicylic acid, methylenebissalicylic acid, β-resorcylic acid, gallic acid, benzoic acid, p-oxy-benzoic acid, pyromellitic acid, .beta.-naphthoic acid, tannic acid, toluic acid, trimellitic acid, phthalic acid, terephthalic acid and anthranalic acid. Examples of aliphatic carboxylic acids are acids with 1 to 20 carbon atoms, preferably 3 to 15 carbon atoms, such as for example stearic acid, 1,2-hydroxystearic acid, tartaric acid, citric acid, oxalic acid and lauric acid. Examples of esters are alkyl esters of aromatic carboxylic acids in which the alkyl group contains 1 to 6 carbon atoms, such as butyl gallate, ethyl-p-hydroxybenzoate and methyl salicylate. Examples that may be cited as salts are ammonium and metal salts of the above-named acids. The metal salts comprise for example lithium, sodium, calcium, magnesium, aluminium, zinc, tin, titanium and nickel salts. Particularly preferred electron acceptors are 1,2-hydroxystearic acid, tartaric acid and citric acid. The above-named electron acceptors can be used alone or mixed with one another. Furthermore, the thermochromic materials can be used as such or in microencapsulated form. Suitable dyes of this type are described in U.S. Pat. No. 4,957,949.

Preferred as thermochromic dyes on the basis of an acid-responsive component and an acidic component are mixtures of an acid-responsive chromogenic substance and an acidic substance (acid component). Preferred acid-responsive substances are triphenylmethane phthalides, phthalides, phthalanes, acyl-leucomethylene blue compounds, fluoranes, triphenylmethanes, diphenylmethanes, spiropyranes and derivatives of these substances. Examplary compounds are 3,6-dimethoxyfluorane, 3,6-di-butoxyfluorane, 3-diethylamino-6,-dimethylfluorane, 3-chloro-6-phenylamino-fluorane, 3-diethylamino-6-methyl-7-chloro-fluorane, 3-diethyl-amino-7,8-benzofluorane, 2-anilino-3-methyl-6-diethylamino-fluorane, 3,3′, 3″-tris(p-dimethylamino-phenyl)phthalide, 3,3′-bis(p-dimethyl-aminophenyl)phthalide, 3-diethylamino-7-phenyl-aminofluorane, 3,3-bis(p-diethylamino-phenyl)-6-dimethylamino-phthalide, 3-(4-diethylaminophenyl)-3-(1-ethyl-2-methylindol-3-yl)phthalide, 3-(4-diet hylamino-2-methyl)phenyl-3-(1,2-dimethylindol-3-yl)phthalide and 2′-(2-chloranilino)-6′-dibutylamino-spiro-[phthalido-3,9′-xanthene].

Preferred acidic substances are 1,2,3-benzotriazoles, phenols, thioureas, oxoaromatic carboxylic acids and derivatives of these substances. Examplary compounds are 5-butylbenzotriazole, bisbenzotrizaol-5-methane, phenol, nonylphenol, bisphenol A, bisphenol F, 2,2′-biphenol, β-naphthol, 1,5-dihydroxynaphthalene, alkyl-p-hydroxybenzoates and phenolic resin oligomers. These dyes can likewise be used as such or in micro-encapsulated form. Suitable dyes of this type are described in U.S. Pat. No. 5,431,697 and can be obtained from the companies Dainichiseika Color & Chemicals Co., Ltd, for example under the name Yellow PP-020® from Hodogaya Chemical Co., Ltd., or from Matsui Shikiso Chemical Co., Ltd., for example under the names Photopia Yellow® or Chromicolor Fast Blue S-17®.

Further preferred thermochromic dyes are liquid crystalline cholesterol derivatives, such as alkanic acid and aralkanic acid esters of cholesterol, alkyl esters of cholesterol carbonate and mixtures thereof, in particular those with alkyl and alkanic acid groups with 1 to 24 carbon atoms. Cholesterol esters and derivatives thereof which contain an alkanic acid group with 9 to 22 carbon atoms or an aralkanic acid group with a benzoic acid group and 1 to 3 carbon atoms in the alkyl part are particularly preferred. In the case of the cholesterol carbonate esters, those with C₁ to C₂₀ alkyl groups are preferred. Suitable compounds of this type are described in U.S. Pat. No. 3,619,254.

Solvatochromic dyes, regardless of specific composition and formulation, are identified and defined in operational terms as a light energy absorbing substance whose absorption and/or emission spectra are sensitive to and altered by the polarity of their surrounding environment-including gaseous, liquid, and/or solid molecules and ions which are temporarily or permanently present in the immediately adjacent spatial volume. The term “solvachromic” is derived from the recognized and long established characteristics of many fluorophores whose fluorescence emission spectra are sensitive to the polarity of the solvents in which they are employed or found. For example, if the emission spectrum of a fluorophore such as 1-anilino-8-naphthalenesulfonyl acid is examined in different solvents of varying polarity, one finds that the emission spectrum shifts to shorter wavelengths (blue shifts) as the solvent polarity is decreased. Conversely, increasing solvent polarity generally results in shifts of the emission spectrum of the fluorophore to longer wavelengths (red shifts). Red shifts are often, but not always, accompanied by a decrease in the quantum yield or total of photons emitted for the fluorophore being evaluated. This phenomenon, the change in emission spectrum of many fluorophores with respect to different solvents of varying polarity, is well known to those skilled in the dye arts. See, U.S. Pat. Nos. 5,244,813; 5,319,975; and 6,140,041.

While the best known examples of solvachromic dyes are fluorophores, the membership of this class as a whole includes both absorbers or chromophores as well as fluorescent molecules. The essential property common to each and every member of this class of dyes is that the chosen dye substance change its spectral properties when exposed to different solvents of varying polarity. For fluorophores, this spectral change can include either an emission intensity charge or a change in the wavelength of the emitted fluorescent light. For an absorber or chromophore dye, the intensity of color may change or the absorption spectrum of the dye may shift either toward the red or the blue end of the spectrum. To determine whether a chosen dye composition is a member of the class defined as a solvachromic dye, the test is solely an empirical one. When the dye is exposed to different organic solvents of varying polarity, the dye changes its color which is empirically observed as a spectral change. Thus, an absorber dye demonstrates a spectral change through its color, either by altering the intensity of the color or by the observation of an actual color change. Alternatively, a fluorescent dye demonstrates its sensitivity to different solvents of varying polarity through changes in either its absorbing exciting light; or by a change in wavelength of the emitted light; or by a change in the intensity of the emitted light.

By this operational definition and the empirical test method through which any person of ordinary skill in this art may identify a chosen dye substance as being a solvachromic dye, it will be recognized and appreciated that the terms “solvachromic” and “polarity-sensitive” are directly related and often interchangeable. The meaning of each of these terms, however, is not exactly alike. To the contrary, the term “polarity-sensitive dye” defines and identifies a dye formulation which is not only sensitive to different solvents of varying polarity, but also to any other organic entity, molecule, or substance which has a discernable-that is, a demonstrable or determinable-polarity. Thus, organic compositions, compounds, and formulations of varying polarity which are not solvents as such are clearly encompassed and included by this term in addition to those compositions which are classically defined as “organic solvents.” Thus, organic solvents constitute merely one group or family within the membership as a whole for the class of organic analytes having a discernable polarity. In this manner, while it is most convenient to test and evaluate a chosen dye using a plurality of solvents of varying polarity to empirically demonstrate that the chosen dye is spectrally influenced and altered by the polarity of the surrounding environment, any other kind or type or organic molecule may also be employed to demonstrate the spectral sensitivity of the chosen dye-albeit under less convenient and/or more rigorous test conditions.

TABLE 1
POLARITY-SENSITIVE FLUOROPHORES

Phospholipid Fluoronhores:
N-(7-nitrobenz-2-oxa-1,3-diazol-4-yl)dipalmittcyl-L-a-
phosphatidylethanolam ine (NBD-PE)
N-(5-fluoresceinthiocarbamoyl)dipalmitoyl-L-a-phosphatidylethanolamine
triethylammonium salt (fluorescein-PE)
N-(6-tetramethylrhodaminethiocarbamoyl)dipalmitoyl-L-a-
phosphatidylethanola mine triethylammonium salt (TRITC DPPE)
N-(Lissamine rhodamine B sulfonyl)dipalmitoyl-L-a-
phosphatidylethanolamine triethylanimonium salt (rhodamine DPPE)
N-(Texas Red sulfonyl)diolsoyl-L-a-phosphatidylethanolamine
triethylammonium salt
N-(Texas Red sulfonyl)dipalmitoyl-L-a-phosphatidylethanolamine
triethylammonium salt (Texas Red DPPE)
3-palmitoyl-2-(1-pyrenedecanoyl)-L-a-phosphatidylcholine (10-py-PC)
N-(5-dimethylaminonaphthalene-1-sulfonyl)dipalmitoyl-L-a-
phosphatidylethano lamine triethylammonium salt
N-(1-pyrenesulfonyl)dipalmitoyl-L-a-phosphatidylethanolamine
triethylammonium salt
N-(6-(5-dimethylaminonaphthalene-1-sulfonyl)amino)hexanoyldipalmitoyl-
L-a-p hosphatidylethanolamine triethylammonium salt
N-(biotinoyl)dipalmitoyl-L-a-phosphatidylethanolamine triethylammonium
salt
Anionic Fluorophores:
cis-parinaric acid
trans-parinaric acid
p-((6-phenyl)-1,3,5-hexatrienyl)benzoic acid (DPH carboxylic acid)
3-(p-(6-phenyl)-1,3,5-hexatrienyl)phenylpropionic acid (DPH propionic acid)
1-pyrenecarboxylic acid
1-pyrenebutanoic acid (pyrenebutyric acid)
1-pyreneonanoic acid
1-pyrenedecanoic acid
1-pyrenedodecanoic acid
1-pyrenehexadecanoic acid
11-((1-pyrenesulfonyl)amino)undecanoic acid
2-(9-anthroyloxy)palmitic acid (2-AP)
2-(9-anthroyloxy)stearic acid (2-AS)
3-(9-anthroyloxy)stearic acid (3-AS)
6-(9-anthroyloxy)stearic acid (6-AS)
7-(9-anthroyloxy)stearic acid (7-AS)
9-(9-anthroyloxy)stearic acid (9-AS)
10-(9-anthroyloxy)stearic acid (10-AS)
11-(9-anthroyloxy)undecanoic acid (11-AU)
12-(9-anthroyloxy)stearic acid (12-AS)
12-(9-anthroyloxy)oleic acid (12-AO)
16-(9-anthroyloxy)palmitic acid (16-AP)
9-anthracenepropionic acid
9-anthracenedodecanoic acid
1-perylenedodecanoic acid
6-(N-(7-nitrobenz-2-oxa-1,3-diazol-4-yl)amino)haxanoic acid (NBD
hexanoic acid)
12-(N-methyl)-N-((7nitrobenz-2-oxa-1,3-diazol-4-yl)amino)dodecanoic acid
12-(N-methyl-N-((7-nitrobenz-2-oxa-1,3-diazol-4-yl)amino)octadecanoic
acid
12-(N-(7-nitrobenz-2-oxa-1,3-diazol-4-yl)amino)dodecanoic acid
11-(9-carbazole)undecanoic acid (11-CU)
11-((5-dimethylaminonaphthalene-1-sulfonyl)amino)undecanoic acid
5-(N-dodecanoyl)aminofluorescein
5-(N-hexadecanoyl)aminofluorescein
5-(N-octadecanoyl)aminofluorescein
5-(N-hexadecanoyl)aminoeosin
1-anilinonaphthalene-8-sulfonic acid (1,8-ANS)
2-anilinonaphthalene-6-sulfonic acid (2,6-ANS)
2-(p-toluidinyl)naphthalene-6-sulfonic acid sodium salt (2,6-TNS)
2-(N-methylanilino)naphthalene-6-sulfonic acid sodium salt (2,6-MANS)
bis-ANS (1,1′-bi(4-anilino)naphthalene-5,5′-disulfonic acid, dipotassium salt)
1-pyrenesulfonic acid, sodium salt
2-(N-octadecyl)aminonaphthalene-6-sulfonic acid, sodium salt
Cationic Fluorophores:
1,1′-dihexadecyloxacarbocyanine, perchlorate (DiOC.sub.16 (3))
3,3′-dioctadecyloxacarboxyanine perchlorate (“DiO”,DiOC.sub.18 (3))
1,1′-didodecyl-3,3,3′,3′-tetramethylindocarbocyanine, perchlorate
(Di1C.sub.12 (3))
1,1′-dihexadecyl-3,3,3′,3′-tetramethyolindocarbocyanine perchlorate
(Di1C.sub.16 (3))
1,1′-dioctadecyl-3,3,3′,3′-tetramethylindocarbocyanine perchiorate (“:Dil”,
DilC.sub.18 (3))
1,1′-didocosanyl-3,3,3′,3′-tetramethylindocarbocyanine perchlorate
(Di1C.sub.22 (3))
1,1′-dioctadecyl-3,3,3′,3′-tetramethylindodicarbocyanine perchiorate
(DilC.sub.18 (5))
3,3′-dioctadecylthiacarbocyanine perchiorate (DiSC.sub.18 (3))
octadecyl rhodamine B, chloride salt (R 18)
rhodamine 6G, octadecyl ester, chloride
rhodamine 101, octadecyl ester, chloride
N-4-(4-didecylaminostyryl)-N-methylpyridinium iodide (4-di-10-ASP)
1-(4-trimethylammoniumphenyl)-6-phenyl-1,3,5-hexatriene,p-
toluenesulfonate (TMA-DPH)
6-palmitoyl-2-(((2-(trimethyl)ammonium)ethyl)methyl)amino)naphthalene,
chloride (PATMAN)
1 -pyrenemethyltrimethylammonium iodide
1 -pyrenebutyltrimethylammonium bromide
3-(-anthracene)propyl trimethylammonium bromide
acridine orange-10-dodecyl bromide (dodecyl acridine orange)
acridine orange-10nonyl bromide (nonyl acridine orange)
Neutral Fluorophores:
1,6-diphenyl- 1,3,5-hexatriene (DPH)
1-phenyl-6-((4-trifluoromethyl)phenyl)-1,3,5-hexatriene (CF-DPH)
palladium disodium alizarinmonosulfonate (Pd(QS).sub.2)
Nile Red or 9-diethylamino-SH-benzo[ ]phenoxazine-5-one
6-propionyl-2-dimethylaminonaphthalene (prodan)
6-dodecanoyl-2-dimethylaminonaphthalene (laurodan)
N-phenyl-11-naphthylamine
1,10-bis-(1-pyrene)decane
1,3-bis-(1-pyrene)propane
p-dimethylaminobenzylidenemalononitrile
N-(5-dimethylaminonaphthalene-1-sulfonyl)hexadecylamine
N-(5-dimethylaminonaphthalene-1-sulfonyl)dihexadecylamine
4-(N,N-dihexadecyl)amino-7-nitrobenz-2-oxa=1,3-diazole (NBD
dihexadecylamine)
4-(N,N-dioctyl)amino-7-nitrobenz-2-oxa-1,3-diazole (NBD-dioctylamine)
4-(hexadecylamino)-7-nitrobenz-2-oxa-1,3-diazole (NBD hexadecylamine)
1-pyrenecarboxaldehyde
1-pyrenenonanol
7-dimethylamino-4-pentadecylcoumarin
cholesteryl anthracene-9-carboxylate
1-pyrenemethyl 36-hydroxyl-22,23-bisnor-5-cholenate (PMC)
1-pyrenemethyl 38-(cis-9-octadecenoyloxy)-22,23-bisnor-5-cholenate (PMC
oleate)
25-(NBD-methylamino)-27-norcholesterol (NBD-MANC)
25-(NBD-methylamino)-27-norcholesteryl oleate (NBD-MANC oleate)
22-(N-(7-nitrobenz-2-oxa-1,3-diazol-4-yl)amino)-23,24-bisnor-5-cholen-38-
ol
22-(N-(7-nitrobenz-2-oxa-1,3-diazol-4-yl)amino)-23,24-bisnor-5-cholen-38-
yl hnoleate
N-(3-sulfopropyl)-4-(p-didecylaminostyryl)pyridinium, inner salt (Dil0ASP-
PS)
3-(N,N-dimethyl-N-(1-pyrenemethyl)ammonium)propanesulfonate, inner salt
4-(N,N-dimethyl-N-(1-pyrenemethyl)ammonium)butanesulfonate, inner salt
N-e-(5-dimethylaminonaphthalene-1-sulfonyl)-L-lysine (dansyl lysine)

TABLE 2
POLARITY-SENSITIVE CHROMOPHORES

Phospholipid Chromophores:
2(3-diphenylhexatrienyl)propanoyl-3-palmitoyl-L-a-phosphatidyl choline
(DPH-PC)
N-(6-(biotinoyl)amino hexanoyl) dipalmitoyl-L-a-phosphatidylethanol-
amine triethyl ammonium salt (biotin-X-DPPE)
N-((4-maleimidylmethyl)cyclohexane-1-carbonyl)dipalmitoyl-L-a-
phosphatidyle thanolamine triethylammonium salt (MMCC-DPPE)
N-((2-pyridyldithio)propionyl)dipalmitoyl-L-a-phosphatidylethanarnine
triethylammonium salt
Anionic Chromophores:
15-phenylpentadecanoic acid
5-(N-hexadecanoyl) amino fluorescein diacetate

The dyes used in the present invention can be added to the polymer as solids, neat liquids, concentrates, emulsions, encapsulated forms of any of these, or any other physical form that is calculated to form a surface coating or homogeneous distribution of dye throughout the fishing line.

In many circumstances, it will be desirable to include one or more additional ingredients in the composition to facilitate color stability and repeated reversibility of the color changing phenomenon. See, U.S. Pat. Nos. 6,733,887 and 6,727,300.

Stabilizing materials can be incorporated into the composition with the color-changing material prior to, simultaneously with, or subsequent to incorporation of the photochromic material in the composition or application as a coating. For example, ultraviolet light absorbers can be admixed with photochromic substances before their addition to the composition or such absorbers can be used as a coating between the photochromic coating and the incident light. In other non-limiting embodiments, further stabilizers can be admixed with the color-changing substances prior to their addition to the coating composition to improve the light fatigue resistance of the color-changing substances. For photochromic dyes, suitable stabilizers include hindered amine light stabilizers (HALS), asymmetric diaryloxalamide (oxanilide) compounds and singlet oxygen quenchers, e.g., a nickel ion complex with an organic ligand, or mixtures thereof. Such stabilizers are generally described in U.S. Pat. Nos. 4,720,356 and 5,391,327, respectively. Suitable amounts of UV stabilizers fall generally within a range from about 1 ppm to 5 wt % based on total composition weight with the specific amount to be determined by the exercise of no more than routine experimentation using a specific dye, polymer, and manufacturing equipment.

HALS scavenge free radicals formed in polymeric material when the material is exposed to UV light. The functional component of the HALS molecule is typically the 2,2,6,6-tetraalkylpiperidine moiety. Typically, the 2,2,6,6-tetraalkylpiperidine moiety is anchored to a carbonyl or melamine functional group. Anchoring the 2,2,6,6-tetraalkylpiperidine moiety to a carbonyl or melamine functional group typically lowers the volatility and extractability of a stabilizer. Low volatility is an important characteristic of light stabilizers in applications where high temperatures are encountered, which occurs frequently in the processing of thermoplastics and in the curing of thermoset resins and coatings. Often, high temperatures are also present in the end-use applications for the stabilized material. Low volatility helps prevent loss of the stabilizer during processing, curing, and high temperature end uses. Typically, HALS molecules containing the 2,2,6,6-tetraalkylpiperidine group anchored to a carbonyl group are made by reacting a 2,2,6,6-tetraalkylpiperidin-4-ol or 4-amino-2,2,6,6-tetramethylpiperidine with a carboxylic acid chloride or ester.

The HALS stabilizers are preferred for use with photochromic dyes according to the present invention. Particularly preferred are HALS stabilizers, such as the TINUVIN™ 622 made by Ciba-Geigy, that are not reactive toward the molten polymer of the product and which do not otherwise reduce the molecular weight of the final polymer when formed into fishing line and which do not impart coloration due to oxidation. If discoloration is found, a chemically compatible antioxidant can be used to prevent or minimize oxidation of the stabilizer. Phosphorous-based antioxidants are preferred with sodium benzene phosphinate and/or benzenephosphinic acid being particularly preferred.

The amount of the color-changing substances described herein to be used in the coatings of the present invention is an amount sufficient to produce a changed color effect that is discernible to the naked eye upon activation. Generally such amount can be described as a “photochromic amount”, a “thermochromic effect”, or similar nomenclature. The color-changing compounds are used in color-changing amounts and in a ratio (when mixtures are used) such that a coating composition to which the compound(s) is applied or in which it is incorporated exhibits a desired resultant color when activated with unfiltered sunlight. The specific amount of color-changing material incorporated into the various embodiments of the invention can vary widely. In general, the amount ranges from about 10 ppm to 40 weight percent based on the weight of the composition containing the dye, e.g., the concentration of photochromic material added to an extrusion melt mixture ranges from about 300 ppm to 5 wt % based on the weight of the total polymeric composition.

Fishing equipment that can be colored according to the invention include fishing products that are made of or which have at least one polymeric part. Exemplary products include fishing lines, fishing rods, guide wrapping thread used on fishing rods, fishing rod handles, fishing reels, fishing lures, artificial baits and bait bodies. For purposes of convenience, the present invention is described in the context of fishing line manufacture although it will be understood by those in the art that other fishing equipment of the types noted above could benefit from the addition of one or more photochromic, thermochromic, or solvatochromic dyes.

Fishing lines represent a line of fishing products that are particularly well suited for the use of color-changing agents. A fishing line that contains a photochromic, thermochromic, or solvachromic dye, pigment, or coloring agent would present the angler with one color above water (due to ambient sunlight, a temperature that is relatively higher than the fished waters, or the absence of submersion in water) and a different color to fish beneath the water. For example, a photochromic line would present a colored line to the angler but be clear or have a reduced color underwater. Thermochromic fishing lines would change from dark below water (where cooled) to a brighter color as the lure approached the warmer surface waters. Such a difference in color presentation would shift the balance in color selection of a fishing line that would let anglers choose their preferred color out of the water and a better color presented to fish under the water. This color change difference also permits the use of a store display that emphasizes the reversible color-changing character of the fishing line so as to distinguish the color-changing fishing lines from competitive lines that do not change color.

Fishing lines according to the invention can be made of any materials that will accept a dye, pigment, or coloring agent to impart a reversible color-changing appearance. Suitable fishing line materials include polyamides, polyesters, polyolefin acrylates, gel spun polyethylenes or fluoropolymers. See, U.S. Pat. Nos. 3,994,990 and 4,338,277 (polyamides); 5,540,990 and 6,148,597 (gel spun polyolefin); 5,625,967 (polyesters); 6,667,067 (fluoropolymers).

The reversible color-changing agent used in the present invention can be applied to or incorporated in the fishing lines by any of the methods conventionally used for incorporating dyes or pigments into the fishing equipment. For example, the reversible color-changing agent can be applied to a fishing line or line guide thread by surface coating or dipping the formed fishing line into a coloring bath containing the agent in a mutually compatible solvent, e.g., water, mineral oil, wax, plasticizer, or organic solvent. The color-changing agent will be used in a concentration within the range from about 1 ppm to about 99 wt %.

The reversible color-changing agent can also be incorporated into a fishing line discretely in the form of a co-extruded inside or outside layer. The color-changing agent is generally mixed with a polymer that is chemically and structurally compatible with the primary fishing line polymer and then co-extruded to form an outer sheath over a central fishing line polymer core.

The reversible color-changing agent can also be incorporated into and homogeneously distributed within the fishing line by (a) adding the reversible color-changing agent to a molten mixture comprising polymer for said fishing line to make a spinnable mixture, (b) spinning said spinnable mixture to make an unoriented polymer line, (c) drawing said polymer line to orient the polymer chains within the polymer line until the properties achieve a tenacity and denier that make the product suitable for use as a fishing line, and (d) dry blending the dye with polymer chips and forming fishing line by melt extrusion or spinning, depending on the fishing line and polymer. Proper selection of a chemically compatible reversible color-changing agent with a degradation point higher than the highest temperature experienced by the fishing line in the melt spinning process will result in a fishing line that exhibits a reversible color-changing character.

Preferably, the reversible color-changing agent is formulated as a colorant concentrate for use as a melt spinning additive. Such colorant concentrates might comprise one or more polymers, oils, waxes, elastomers, or plasticizers.

Fishing equipment according to claim 2 wherein said fishing line exhibits a tenacity within the range from about 5 to about 50 g/denier (or higher, if possible) with a tensile modulus in the range from about 15 to at least about 500 g/denier. Nylon monofilaments have a modulus generally within the range of 20-50 g/d while gel spun polyolefin fishing lines (“superlines”) exhibit a tenacity of at least about 500 g/d.

All patents disclosed and referenced are herein incorporated by reference.

1. Fishing equipment according to the invention comprises a product useful in the sport of fishing and made of or having a composition comprising: (a) at least one polymeric component; and (b) at least one reversible color-changing agent comprising a dye, pigment, or formulation disposed within, on, or distributed throughout said polymeric component, wherein said reversible color-changing agent is selected from the group consisting of a photochromic, thermochromic, and solvatochromic material that changes its perceived color as a consequence of a change in ambient electromagnetic radiation, temperature, or moisture level, respectively.

2. Fishing equipment according to claim 1 wherein said product is a fishing line.

3. Fishing equipment according to claim 2 wherein said fishing line is made of polyamide, polyester, polyolefin, gel spun polyethylene or fluoropolymer.

4. Fishing equipment according to claim 3 wherein said fishing line is made of polyamide.

5. Fishing equipment according to claim 3 wherein said fishing line is made of polyolefin.

6. Fishing equipment according to claim 3 wherein said fishing line is made of gel spun polyethylene.

7. Fishing equipment according to claim 3 wherein said fishing line is made of fluoropolymer.

8. Fishing equipment according to claim 2 wherein said reversible color-changing agent is applied to said fishing line by surface coating or dipping said fishing line in a solution comprising said agent.

9. Fishing equipment according to claim 2 wherein said reversible color-changing agent is mixed with a compatible polymer and applied to said fishing line by co-extrusion in an outer layer around said fishing line.

10. Fishing equipment according to claim 2 wherein said reversible color-changing agent is incorporated into said fishing line by (a) adding said reversible color-changing agent to a molten mixture comprising monomer for said fishing line to make a spinnable mixture, (b) spinning said spinnable mixture to make an unoriented polymer line, and (c) drawing said polymer line orient polymers within said polymer line to a tenacity and denier suitable for use as a fishing line.

11. Fishing equipment according to claim 10 wherein said reversible color-changing agent is added to said molten mixture as a colorant concentrate.

12. Fishing equipment according to claim 10 wherein said colorant concentrate comprises a polymer, oil, water, wax, elastomer, or plasticizer.

13. Fishing equipment according to claim 1 wherein said composition further comprises an ultraviolet stabilizer or an antioxidant.

14. Fishing equipment according to claim 13 wherein said stabilizer is a hindered amine light stabilizer.

15. Fishing equipment according to claim 1 wherein said products comprises a fishing lure.

16. Fishing equipment according to claim 15 wherein said fishing lure has a soft body.

17. Fishing equipment according to claim 1 wherein said product comprises thread wrapped around a line guide foot on a fishing rod.

18. Fishing equipment according to claim 1 wherein said product comprises a fishing rod blank.

19. Fishing equipment according to claim 19 wherein a reversible color-changing agent has been incorporated into prepreg used to form said fishing rod blank.

20. Fishing equipment according to claim 19 wherein a reversible color-changing agent has been incorporated into a protective fishing coat on said fishing rod blank.

21. Fishing equipment according to claim 2 wherein said reversible color-changing agent is a photochromic material.

22. Fishing equipment according to claim 21 wherein the photochromic material has at least one activated absorption maxima within the range of between about 400 and 700 nanometers.

23. Fishing equipment according to claim 21 further comprising a stabilizing agent for said photochromic material.

24. Fishing equipment according to claim 23 wherein the photochromic material is selected from the group consisting of spiropyran compounds, spirooxazine compounds, pyran compounds and oxazine compounds.
